(19) United States
(12) Patent Application Publication
(10) Pub. No.: US 2018/0205818 A1
(43) Pub. Date: Jul. 19, 2018

(54) MECHANISM FOR INDICATING TRANSPORT INFRASTRUCTURE COMPATIBILITY TO CONTACTLESS APPLICATION INSTALLERS

(71) Applicant: QUALCOMM Incorporated, San Diego, CA (US)

(72) Inventor: John HILLAN, Alton (GB)

(21) Appl. No.: 15/480,100

(22) Filed: Apr. 5, 2017

Related U.S. Application Data
(60) Provisional application No. 62/446,251, filed on Jan. 13, 2017.

(51) Int. Cl. H04M 1/725; H04W 4/00; H04W 8/22; G06Q 20/32

(52) U.S. Cl. CPC H04M 1/72577; H04W 4/008; H04B 5/0025; G06Q 20/327; H04W 8/22

(57) ABSTRACT

Transportation systems and infrastructure increasingly use wireless communication systems to provide access and payment methods for users. Because the wireless communication systems across transportation platforms differ, a need exists to indicate whether a device is interoperable with different systems. In an aspect, a method, an apparatus, a computer-readable medium are provided. The apparatus may be configured to detect on the apparatus a contactless application for accessing transportation infrastructure. The apparatus may be configured to determine whether the apparatus is compatible with device requirements of the contactless application for accessing transportation infrastructure and to provide a compatibility indication based on the determination.

### CROSS-REFERENCE TO RELATED APPLICATION(S)

This application claims the benefit of U.S. Provisional Application Ser. No. 62/446,251, entitled “MECHANISM FOR INDICATING TRANSPORT INFRASTRUCTURE COMPATIBILITY TO CONTACTLESS APPLICATION INSTALLERS” and filed on Jan. 13, 2017, which is expressly incorporated by reference herein in its entirety.

### BACKGROUND

### Field

The present disclosure relates generally to communication systems, and more particularly, to a mechanism for indicating transport infrastructure interoperability with wireless devices based on contactless application installation, activation, or use.

### Background

Wireless communication systems are widely deployed to provide various telecommunication services such as telephony, video, data, messaging, and broadcasts. Wireless communication systems are also increasingly used to support transportation infrastructure and systems, including providing access and payment methods for users seeking to gain access to various forms of transportation, such as public transportation in railways and buses. With a diverse set of technology and infrastructure used to support transportation networks, a need exists for a global device that is compatible with or indicates compatibility with the different transportation infrastructure technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Wireless communications systems that support short-range communications may enable access and payment methods for transportation systems. Short-range communications may include near field communication (NFC) technology, Bluetooth technology, and others. The short-range communication systems may vary across different system platforms. For example, general-purpose NFC solutions may be based on existing NFC forum specifications. A challenge of utilizing NFC solutions with existing public transportation infrastructure, such as subway station entry gates, is that different NFC solutions may utilize different physical layer parameters, which means that RF communication cannot be guaranteed. For example, RF communication with older physical layer technology may not be guaranteed due to compatibility issues. Newer technology, however, may be used to confirm compatibility with existing technology. A need exists to improve the indication of infrastructure compatibility.

In an aspect of the disclosure, a method, a computer-readable medium, and an apparatus are provided. An apparatus may be configured to detect on the apparatus a contactless application for accessing transportation infrastructure, to determine whether the apparatus is compatible with device requirements of the contactless application for accessing transportation infrastructure based on device capabilities associated with the apparatus, and to provide a compatibility indication based on the determination.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a mechanism for indicating transport infrastructure compatibility.

FIG. 2 illustrates first, second, and third prompts of a wireless device operating a contactless application.

FIG. 3 is a flowchart of a method of wireless communication.

FIG. 4 is a conceptual data flow diagram illustrating the data flow between different means/components in an exemplary apparatus.

FIG. 5 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

Transportation infrastructure may utilize different forms of technology to enable user access, payment methods, and other features. For example, NFC may be used to provide transportation users access through entry gates, such as subway station entry gates. Different transportations systems may adopt different NFC solutions. In some instances, a user that downloads and installs on a mobile device an application designed to communicate with different transportation infrastructures may discover that, while the application may be installed, the device lacks the capabilities for communicating with the deployed transportation technology. Because different transportation infrastructures may use different communication technologies with different physical layer parameters, interoperability between wireless devices and the infrastructure is not guaranteed. Allowing users to install applications that appear to provide interoperability but actually do not may cause confusion and annoyance and could even pose a safety hazard if access is denied to many users at busy entry points. One method of avoiding incompatibility is to mandate that all public transportation systems across the world modify their infrastructure to be compatible with existing mobile devices, but public transportation infrastructure and other forms of transportation infrastructure are typically large, long-lived, and difficult to change. Modifying the mobile device to indicate compatibility with the transportation system is more effective.

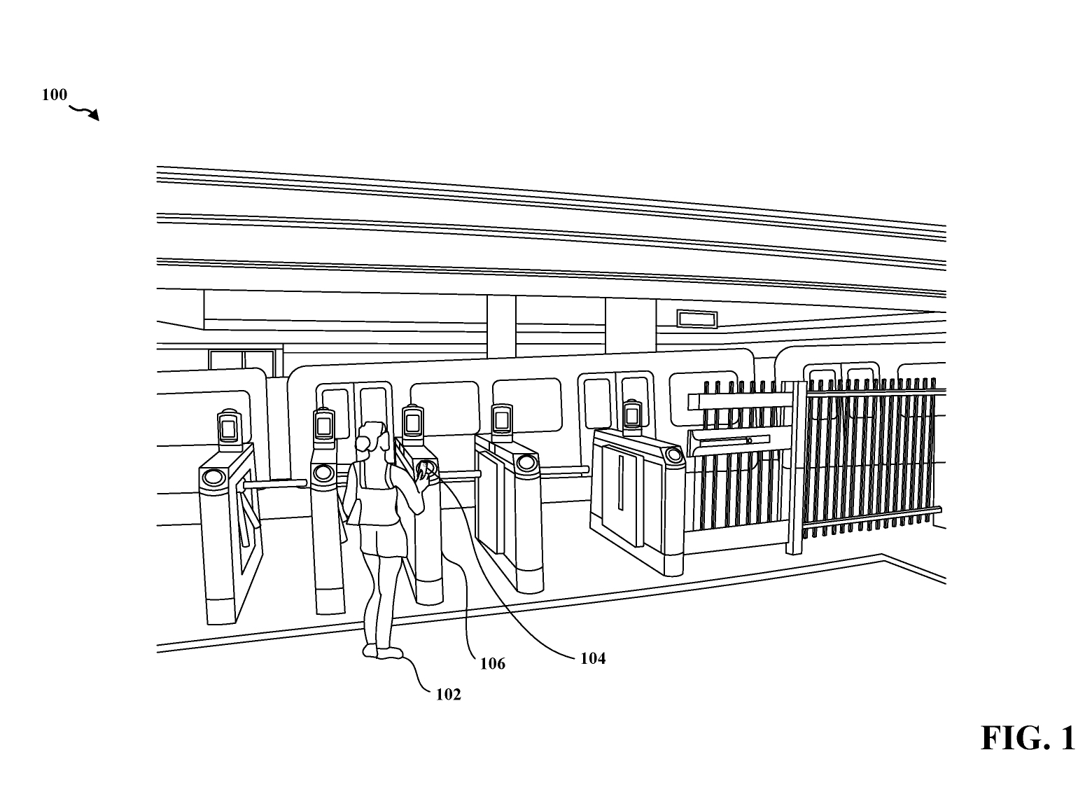

FIG. 1 is a diagram 100 illustrating a mechanism for indicating transport infrastructure compatibility. Referring to FIG. 1, a user 102 may be seeking to access to a transportation network (e.g., a train station) using a wireless device 104 (e.g., a mobile telephone). The user 102 may install a contactless application (or a contactless transit access application) onto the wireless device 104 The contactless application may be an application that supports NFC or other short-range communication protocols, enabling the user 102 with the wireless device 104 to perform a contactless scan of the wireless device 104 at a kiosk 106 (e.g., an entry gateway/kiosk) to access a mode of transportation (e.g., a train or a bus). That is, the user 102 may position the wireless device 104 within a maximum distance of the kiosk 106 to gain access to the mode of transportation. The kiosk 106 may be part of a transportation infrastructure operating on one or more types of wireless communication systems, including NFC. Because different transportation infrastructures may operate different communication systems, depending on the capabilities of the wireless device 104, the user 102 may or may not be able to use the contactless application to gain access to the mode of transportation via the kiosk 106.

Rather than installing the contactless application and only notifying the user 102 of whether the application works at the point of use (e.g., the kiosk 106), the wireless device 104 and/or the contactless application may verify whether the contactless application is interoperable with the wireless device 104 at an earlier time, such as when the contactless application is stored or installed or when the contactless application is activated (e.g., first launched or when personalized by entering identifying information (such as login information or payment information) on the wireless device 104). The wireless device 104 may detect that the contactless application is on the wireless device 104 when the contactless application is being stored or installed on, activated on, or used on the wireless device 104. When the wireless device 104 determines that the contactless application is related to accessing transportation, then the wireless device 104 may determine whether the wireless device 104 is compatible with the requirements of the contactless application for enabling the user 102 to access transportation infrastructure of interest to the user 102. In one aspect, the user 102 may select one or more types of transportation infrastructures to access via the contactless application. The transportation infrastructure may be selected based on location information (e.g., a location of the train station and/or the location of the user 102 using global positioning system (GPS) or global navigation satellite system (GNSS) information), the name of the transportation service (e.g., name of a train station or name of a transportation entity), an identifier identifying the transportation infrastructure, or other information. For example, the contactless application may provide the user 102 with a list of transportation infrastructures that are nearby to the user 102. The wireless device 104 may determine the requirements for contactless access at the different transportation infrastructures. The requirements may include NFC requirements or other communication protocol requirements. For example, the NFC requirements may include NFC coding requirements, NFC security requirements, communication range requirements, and/or NFC data rate requirements. The wireless device 104 may compare the requirements to the capabilities of the wireless device 104. In an aspect, if the capabilities of the wireless device 104 meet the requirements for a selected transportation infrastructure, then the wireless device 104 may alert or indicate to the user 102 that the contactless application may be used to access the selected transportation infrastructure. For example, the wireless device 104 may perform a query for a communication capability/property, and if the property is supported, then the wireless device 104 may return a value of TRUE, indicating interoperability with the transport infrastructure. By contrast, if the capabilities of the wireless device 104 do not meet the requirements for the selected transportation infrastructure, then the wireless device 104 may alert or indicate to the user 102 that the wireless device 104 is incompatible with and cannot be used to access the selected transportation infrastructure. For example, if the queried property is not supported, then the wireless device 104 may return a value of FALSE, indicating no interoperability with the transport infrastructure. The queried property may be one of the requirements mentioned previously or may be another communication requirement. If the wireless device 104 is incompatible with the selected transportation infrastructures, then the wireless device 104 may disable the contactless application by preventing the application from being used to access the selected transportation infrastructure. The wireless device 104 may automatically uninstall or provide the user 102 with the option to uninstall the contactless application. If the wireless device 104 is compatible with a subset but not all of the selected transportation infrastructures, then the wireless device 104 may indicate which transportation infrastructures are compatible and incompatible with the wireless device 104 and prevent the contactless application from being used on the incompatible transportation infrastructure.

In another aspect, the wireless device 104 may display a message to the user 102 indicating one or more reasons for which the transportation infrastructure selected by the user 102 is not supported by the wireless device 104. For example, the wireless device 104 may indicate that certain NFC requirements are not supported or that NFC is not available on the wireless device 104.

In another aspect, upon installation of the contactless application, the wireless device 104 may determine the capabilities of the wireless device 104, compare the capabilities with all of the known requirements of different transportation infrastructures supported by the contactless application, and determine which requirements associated with the contactless application are compatible with the wireless device 104. Subsequently, the wireless device 104 may display only the transportation networks that are compatible with the wireless device 104 and hide or disable other transportation networks.

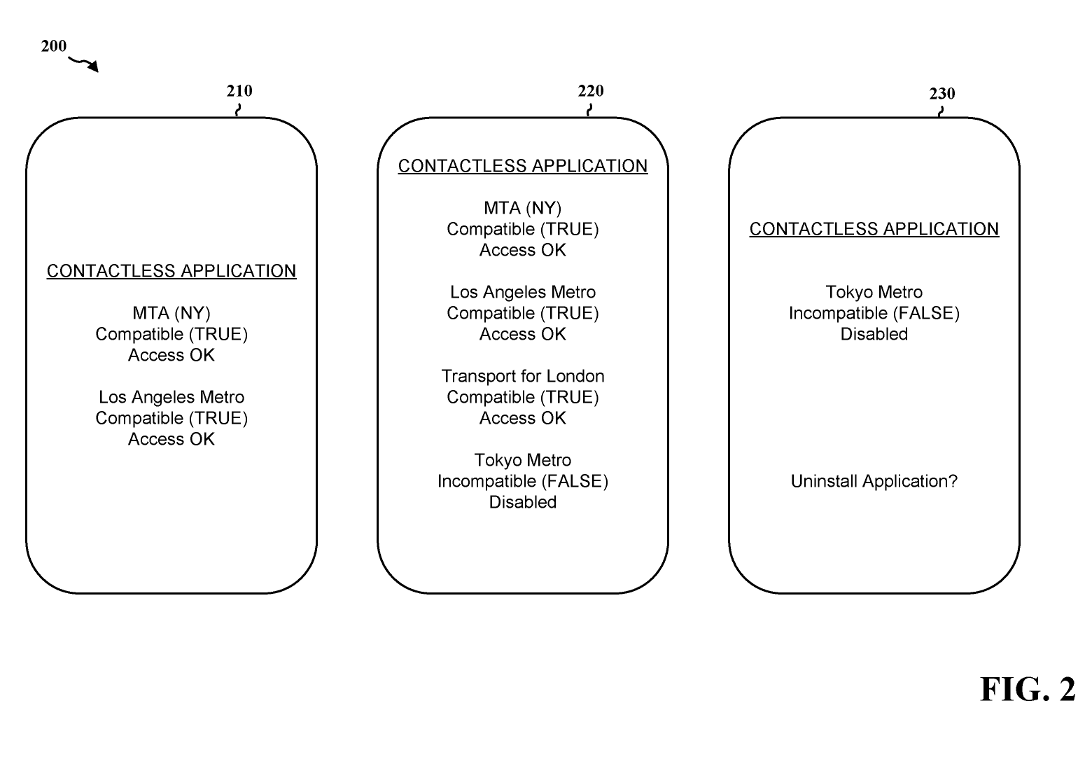

FIG. 2 illustrates first, second, and third prompts 210, 220, 230 of a wireless device operating a contactless application. Referring to the first prompt 210, in one aspect, the user 102 may install the contactless application and select the MTA in NY and the Los Angeles Metro as transportation networks of interest. The wireless device 104 may determine that infrastructure requirements for both transit networks are supported by the wireless device 104, and therefore, may return values of TRUE, indicating interoperability with the transit infrastructure. In another instance, upon installing the contactless application and without input from the user 102, the wireless device 104 may determine that the wireless device 104 supports contactless access at the MTA in New York and the Los Angeles Metro based on the capabilities of the wireless device 104. In this instance, the MTA in NY and the Los Angeles Metro may be determined based on a previously stored travel history of the user 102. In another instance, upon installing the contactless application, the wireless device 104 may identify a list of public transportation infrastructures close to the user 102 (e.g., based on GPS information) and indicate which public transportation infrastructures are compatible and/or not compatible with the wireless device 104.

Referring to the second prompt 220, the user 102 may select MTA, Los Angeles, Metro, Transport for London, and Tokyo Metro as transportation infrastructure of interest to the user 102. Based on the user selection, the wireless device 104 may determine the requirements for transportation access for each of the transportation networks in the different geographical locations. The wireless device 104 may determine that the wireless device 104 may support the transportation infrastructure in New York, Los Angeles, and London but not in Tokyo. Accordingly, the wireless device 104 may provide an indication of which transportation infrastructure, as selected by the user 102, is supported and which transportation infrastructure is not supported.

Referring to the third prompt 230, the user 102 determine that Tokyo Metro is a transportation network of interest. The wireless device 104, however, may determine that the wireless device 104 cannot support the wireless communication systems deployed by Tokyo Metro. The wireless device 104 may indicate a lack interoperability between the wireless device 104 and the selected network. Because no other transportation networks are of interest, the wireless device 104 may provide the user 102 with an option to uninstall the contactless application.

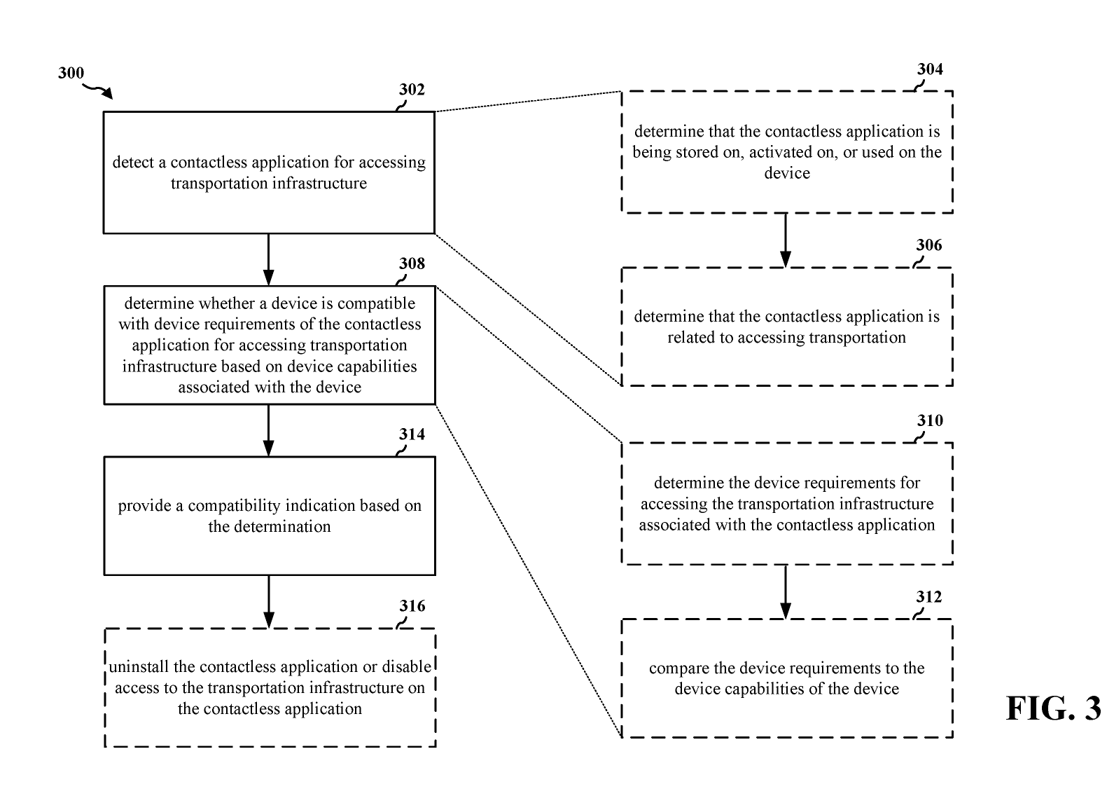

FIG. 3 is a flowchart 300 of a method of wireless communication. The method may be performed by a wireless device (e.g., the wireless device 104, the apparatus 402/402′). At 302, the wireless device may detect a contactless application for accessing transportation infrastructure. In one configuration, the wireless device may detect the installation by determining the contactless application is being stored on the wireless device (at 304) and by determining that the contactless application is related to accessing transportation infrastructure (at 306). For example, referring to FIG. 1, the wireless device may be the wireless device 104. The wireless device 104 may detect that a contactless application is on the wireless device 104 when the application is stored, installed, activated, or used on the wireless device 104. The wireless device 104 may determine that the contactless application is related to access transportation based on an identifier or a descriptor associated with the contactless application. The identifier or the descriptor may indicate that the contactless application is associated with applications for accessing transportation infrastructure.

At 308, the wireless device may determine whether the wireless device is compatible with device requirements of the contactless application for accessing transportation infrastructure based on device capabilities associated with the wireless device. In one configuration, the wireless device may determine whether the wireless device is compatible by determining the device requirements for accessing the transportation infrastructure associated with the contactless application (e.g., the transportation infrastructure selected by the user 102 or by the contactless application based on the location of the user 102 and nearby transportation infrastructures) (at 310) and by comparing the device requirements to the device capabilities of the wireless device (at 312). For example, referring to FIG. 1, the wireless device 104 may determine whether the wireless device 104 is compatible with the device requirements of the contactless application by determining the device requirements for various transportation infrastructure of interest to the user 102, such as the Tokyo Metro, and by comparing the device requirements for the transportation infrastructure at Tokyo Metro to the device capabilities of the wireless device 104.

At 314, the wireless device may provide a compatibility indication based on the determination. For example, referring to FIG. 1, if the wireless device 104 is compatible with the transportation infrastructure of interest, then the wireless device 104 may indicate that the user 102 may use the contactless application to access the transportation infrastructure (e.g., return value of TRUE) at Tokyo Metro, for example. If the wireless device 104 is incompatible with the transportation infrastructure of interest, then the wireless device 104 may indicate to the user 102 that the wireless device 104 is incompatible with the selected transportation infrastructure.

At 316, the wireless device may uninstall the contactless application or disable access to the transportation infrastructure on the contactless application. For example, referring to FIG. 1, the wireless device 104 may uninstall, remove, or delete from storage the contactless application based on the determination that none of the transportation infrastructures of interest to the user 102 are compatible with the wireless device 104. In another example, the wireless device 104 may disable access to the transportation infrastructure that is not interoperable with the wireless device 104 but allow access to the transportation infrastructure that is interoperable with the wireless device 104.

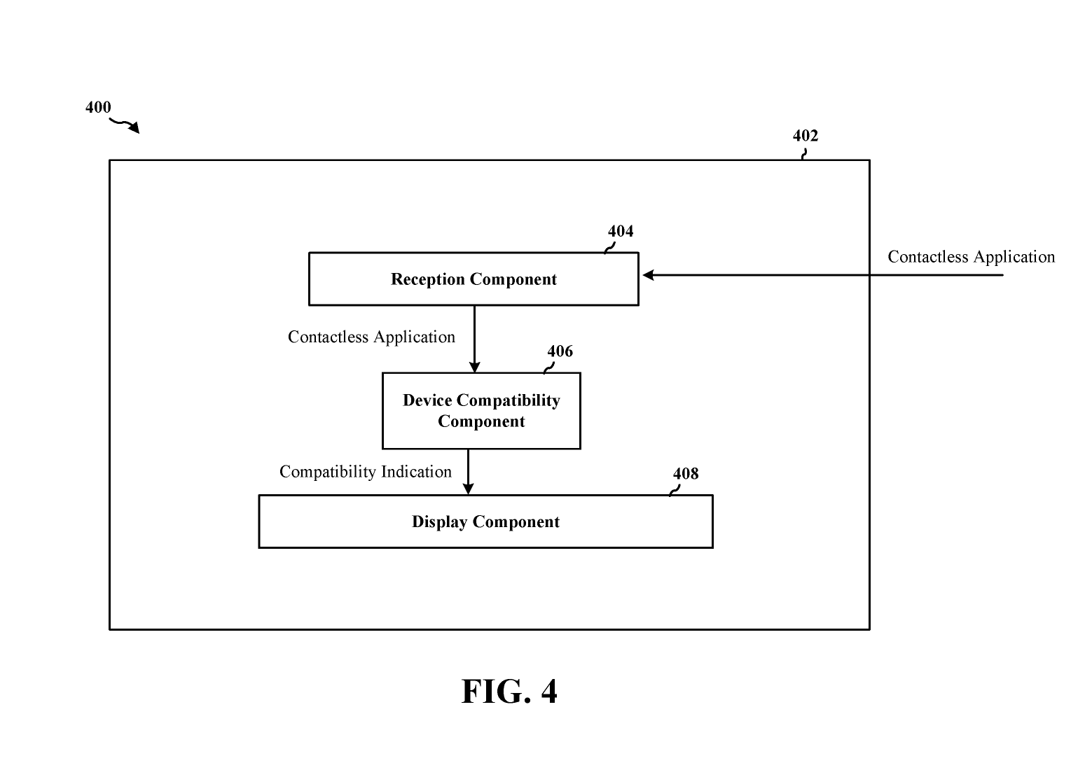

FIG. 4 is a conceptual data flow diagram 400 illustrating the data flow between different means/components in an exemplary apparatus 402. The apparatus may be a wireless device. The apparatus includes a reception component 404, a device compatibility component 406, and a display component 408. The reception component 404 may be configured to receive or downlink a contactless application for accessing transportation infrastructure. The device compatibility component 406 may be configured to detect on the apparatus a contactless application for accessing transportation infrastructure. The device compatibility component 406 may be configured to determine whether the apparatus is compatible with device requirements of the contactless application for accessing transportation infrastructure based on device capabilities associated with the apparatus. The display component 408 may be configured to provide a compatibility indication based on the determination. In one configuration, the device compatibility component 406 may be configured to detect by determining that the contactless application is being stored on, activated on, or used on the apparatus and by determining that the contactless application is related to accessing transportation. In another configuration, the device compatibility component 406 may be configured to determine by determining the device requirements for accessing the transportation infrastructure associated with the contactless application and by comparing the device requirements to the device capabilities of the apparatus. In another configuration, the apparatus determines that the apparatus is incompatible with the device requirements for accessing the transportation infrastructure associated with the contactless application and the compatibility indication indicates that the apparatus is incompatible with the transportation infrastructure. In this configuration, the device compatibility component 406 may be configured to uninstall the contactless application or to disable access to the transportation infrastructure on the contactless application. In another aspect, the apparatus determines that the apparatus is compatible with the device requirements for accessing the transportation infrastructure associated with the contactless application, and the compatibility indication may indicate that the apparatus is compatible with the transportation infrastructure. In another aspect, the device requirements may include at least one NFC coding requirements, NFC security requirements, communication range requirements, or NFC data rate requirements.

The apparatus may include additional components that perform each of the blocks of the algorithm in the aforementioned flowcharts of FIG. 3. As such, each block in the aforementioned flowcharts of FIG. 3 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

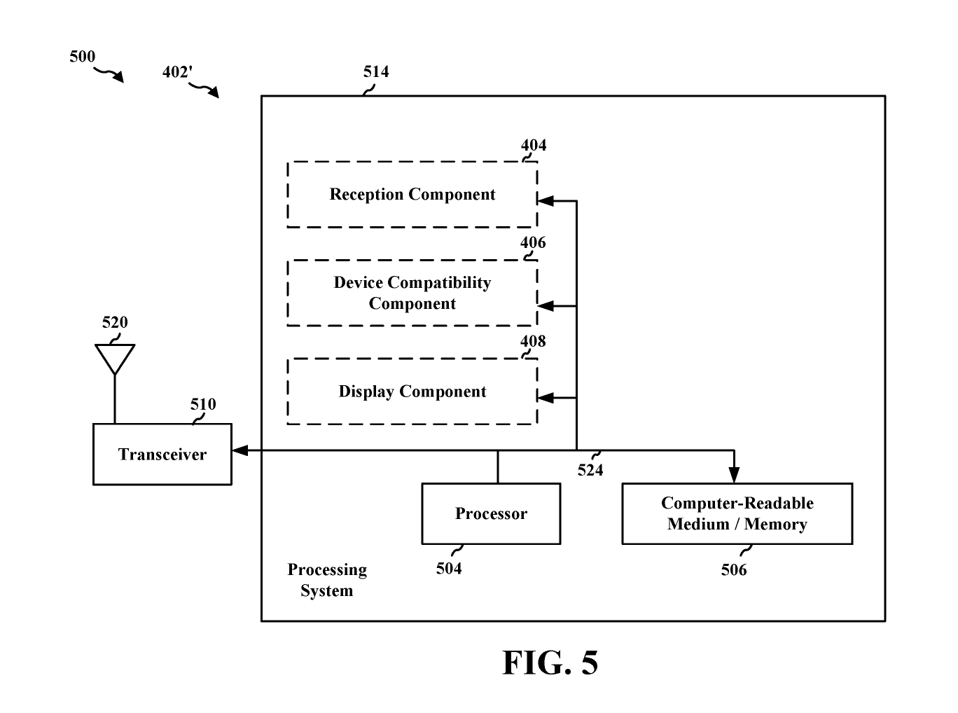

FIG. 5 is a diagram 500 illustrating an example of a hardware implementation for an apparatus 402′ employing a processing system 514. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the components 404, 406, 408, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 404. In addition, the transceiver 510 receives information from the processing system 514, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the components 404, 406, 408. The components may be software components running in the processor 504, resident/stored in the computer readable medium/memory 506, one or more hardware components coupled to the processor 504, or some combination thereof. The processing system 514 may include the memory and/or at least one of the TX processor, the RX processor, and a controller/processor.

In one configuration, the apparatus 402/402′ for wireless communication includes means for detecting on the apparatus a contactless application for accessing transportation infrastructure. The apparatus may include means for determining whether the apparatus is compatible with device requirements of the contactless application for accessing transportation infrastructure based on device capabilities associated with the apparatus. The apparatus may include means for providing a compatibility indication based on the determination. In one configuration, the means for detecting may be configured to determine that the contactless application is being stored on, activated on, or used on the apparatus and to determine that the contactless application is related to accessing transportation. In another configuration, the means for determining may be configured to determine the device requirements for accessing the transportation infrastructure associated with the contactless application and to compare the device requirements to the device capabilities of the apparatus. In another configuration, the apparatus determines that the apparatus is incompatible with the device requirements for accessing the transportation infrastructure associated with the contactless application and the compatibility indication indicates that the apparatus is incompatible with the transportation infrastructure. In this configuration, the apparatus may include means for uninstalling the contactless application or means for disabling access to the transportation infrastructure on the contactless application. The means for disabling access may be configured to identify the transportation infrastructure that is not interoperable with the apparatus and to restrict user access to the transportation infrastructure. In another aspect, the apparatus may determine that the apparatus is compatible with the device requirements for accessing the transportation infrastructure associated with the contactless application, and the compatibility indication may indicate that the apparatus is compatible with the transportation infrastructure. In another aspect, the device requirements may include at least one NFC coding requirements, NFC security requirements, communication range requirements, or NFC data rate requirements. The aforementioned means may be one or more of the aforementioned components of the apparatus 402 and/or the processing system 514 of the apparatus 402′ configured to perform the functions recited by the aforementioned means. As described, the processing system 514 may include a TX Processor, an RX Processor, and a controller/processor. As such, in one configuration, the aforementioned means may be the TX Processor, the RX Processor, and the controller/processor configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication by a device, comprising:
detecting on the device a contactless application for accessing transportation infrastructure;
determining whether the device is compatible with device requirements of the contactless application for accessing transportation infrastructure based on device capabilities associated with the device; and
displaying a compatibility indication based on the determination, the compatibility indication including a message that indicates if the device is compatible with the transportation infrastructure.

2. The method of claim 1, wherein the detecting comprises:
determining that the contactless application is being stored on, activated on, personalized on, or used on the device; and
determining that the contactless application is related to accessing transportation.

3. The method of claim 1, wherein the determining comprises:
determining the device requirements for accessing the transportation infrastructure associated with the contactless application; and
comparing the device requirements to the device capabilities of the device.

4. The method of claim 1, wherein the device determines that the device is incompatible with the device requirements for accessing the transportation infrastructure associated with the contactless application, wherein the compatibility indication indicates that the device is incompatible with the transportation infrastructure.

5. The method of claim 4, further comprising uninstalling the contactless application or disabling access to the transportation infrastructure on the contactless application based on the determination that the device is incompatible with the device requirements.

6. The method of claim 1, wherein the compatibility indication includes a displayed message that indicates if the device is compatible with the transportation infrastructure.

7. The method of claim 1, wherein the device requirements comprise at least one near field communication (NFC) coding requirements, NFC security requirements, communication range requirements, NFC data rate requirements, or other NFC parameters.

8. A device for wireless communication, comprising:
means for detecting on the device a contactless application for accessing transportation infrastructure;
means for determining whether the device is compatible with device requirements of the contactless application for accessing transportation infrastructure based on device capabilities associated with the device; and
means for displaying a compatibility indication based on the determination, the compatibility indication including a message that indicates if the device is compatible with the transportation infrastructure.

9. The device of claim 8, wherein the means for detecting is configured to:
determine that the contactless application is being stored on, activated on, personalized on, or used on the device; and
determine that the contactless application is related to accessing transportation.

10. The device of claim 8, wherein the means for determining is configured to:
determine the device requirements for accessing the transportation infrastructure associated with the contactless application; and compare the device requirements to the device capabilities of the device.

11. The device of claim 8, wherein the device determines that the device is incompatible with the device requirements for accessing the transportation infrastructure associated with the contactless application, wherein the compatibility indication indicates that the device is incompatible with the transportation infrastructure.

12. The device of claim 11, further comprising means for uninstalling the contactless application or means for disabling access to the transportation infrastructure on the contactless application based on the determination that the device is incompatible with the device requirements.

13. The device of claim 8, wherein the compatibility indication includes a displayed message that indicates if the device is compatible with the transportation infrastructure.

14. The device of claim 8, wherein the device requirements comprise at least one near field communication (NFC) coding requirements, NFC security requirements, communication range requirements, NFC data rate requirements, or other NFC parameters.

15. A device for wireless communication, comprising:
a memory; and
at least one processor coupled to the memory and configured to:
detect on the device a contactless application for accessing transportation infrastructure;
determine whether the device is compatible with device requirements of the contactless application for accessing transportation infrastructure based on device capabilities associated with the device; and
display a compatibility indication based on the determination, the compatibility indication including a message that indicates if the device is compatible with the transportation infrastructure.

16. The device of claim 15, wherein the at least one processor is configured to detect by:
determining that the contactless application is being stored on, activated on, personalized on, or used on the device; and
determining that the contactless application is related to accessing transportation.

17. The device of claim 15, wherein the at least one processor is configured to determine by:
determining the device requirements for accessing the transportation infrastructure associated with the contactless application; and
comparing the device requirements to the device capabilities of the device.

18. The device of claim 15, wherein the device determines that the device is incompatible with the device requirements for accessing the transportation infrastructure associated with the contactless application, wherein the compatibility indication indicates that the device is incompatible with the transportation infrastructure.

19. The device of claim 18, wherein the at least one processor is further configured to uninstall the contactless application or to disable access to the transportation infrastructure on the contactless application based on the determination that the device is incompatible with the device requirements.

20. The device of claim 15, wherein the compatibility indication includes a displayed message that indicates if the device is compatible with the transportation infrastructure.

21. The device of claim 15, wherein the device requirements comprise at least one near field communication (NFC) coding requirements, NFC security requirements, communication range requirements, NFC data rate requirements, or other NFC parameters.

22. A computer-readable medium of a device storing computer executable code for a device, comprising code to:
detect on the device a contactless application for accessing transportation infrastructure;
determine whether the device is compatible with device requirements of the contactless application for accessing transportation infrastructure based on device capabilities associated with the device; and
display a compatibility indication based on the determination, the compatibility indication including a message that indicates if the device is compatible with the transportation infrastructure.
